(19) United States
(12) Patent Application Publication
(10) Pub. No.: US 2026/0214490 A1
(43) Pub. Date: Jul. 23, 2026

(54) INFORMATION REPORTING METHOD AND APPARATUS, INFORMATION RECEIVING METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Min LIU, Beijing (CN)

(73) Assignee: Beijing Xiaomi Mobile Software Co., Ltd., Beijing (CN)

(21) Appl. No.: 19/145,436

(22) PCT Filed: Jan. 3, 2023
(86) PCT No.: PCT/CN2023/070241

§ 371 Date: Jul. 2, 2025

(51) Int. Cl. H04W 24/10; H04L 1/00

(52) U.S. Cl. CPC H04W 24/10; H04L 1/0002

(57) ABSTRACT

Embodiments of the present disclosure provide an information reporting method and apparatus, an information receiving method and apparatus, a communication device, and a storage medium. The method is executed by a terminal. The method includes: sending, to a network device, performance information of a model based on different overhead parameters, wherein the model is used for performing channel state information (CSI) encoding on the basis of the overhead parameters. Here, since the terminal sends the performance information to the network device, after the network device receives the performance information, the network device can determine, on the basis of the performance information, a first overhead parameter used for compressing the CSI by the model. Compared with the manner of randomly determining an overhead parameter for compressing the CSI by the model, the method may adapt to the performance of the model.

### CROSS-REFERENCE TO RELATED APPLICATIONS

The present application is a U.S. National Stage of International Application No. PCT/CN2023/070241, filed on Jan. 3, 2023, the content of which is incorporated by reference herein in its entirety for all purposes.

### TECHNICAL FIELD

The present disclosure relates to the field of wireless communication technology but is not limited to the field of wireless communication technology, and in particular to an information reporting method, an information receiving method, an apparatus, a communication device and a storage medium.

### BACKGROUND

In a wireless communication system, in order to ensure the communication quality of wireless communication, it is necessary to estimate the channel characteristics of wireless communication between the terminal and the base station, and transmit signals based on the characteristics. In order to accurately estimate the channel characteristics, the terminal can feed back the channel state information (CSI) reflecting the channel characteristics to the base station. Based on the CSI, the base station can select appropriate communication parameters for communication to ensure the communication quality.

### SUMMARY

The embodiments of the present disclosure provide an information reporting method, an information receiving method, an apparatus, a communication device and a storage medium.

According to a first aspect of the embodiments of the present disclosure, there is provided a method for reporting information, performed by a terminal, including:
sending performance information of a model based on different overhead parameters to a network device;
where the model is configured to encode channel state information CSI based on the overhead parameters.

According to a second aspect of the embodiments of the present disclosure, there is provided a method for receiving information, performed by a network device, including:
receiving performance information of a model based on different overhead parameters sent by a terminal;
where the model is configured to encode channel state information CSI based on overhead parameters.

According to a third aspect of the embodiments of the present disclosure, there is provided a device for reporting information, including:
a sending module configured to send performance information of a model based on different overhead parameters to a network device;
where the model is configured to encode channel state information CSI based on the overhead parameters.

According to a fourth aspect of the embodiments of the present disclosure, there is provided device for receiving information, including:
a receiving module configured to receive performance information of a model based on different overhead parameters sent by a terminal;
where the model is configured to encode channel state information CSI based on the overhead parameters.

According to a fifth aspect of the embodiments of the present disclosure, there is provided communication device, including:
a processor;
a memory;
wherein the processor is configured to implement the method according to any embodiment of the present disclosure.

According to a sixth aspect of the embodiments of the present disclosure, there is provided a non-transitory computer storage medium, where the computer storage medium stores computer executable instructions, and the computer executable instructions can implement the method according to any embodiment of the present disclosure after being executed by the processor.

### BRIEF DESCRIPTION OF THE DRAWINGS

FIG. 1 is a schematic diagram of a structure of a wireless communication system according to an example embodiment.

FIG. 2 is a schematic diagram of a flow chart of a method for indicating information of an antenna port according to an example embodiment.

FIG. 3 is a schematic diagram of a flow chart of an information reporting method according to an example embodiment.

FIG. 4 is a schematic diagram of a flow chart of an information reporting method according to an example embodiment.

FIG. 5 is a schematic diagram of a flow chart of an information reporting method according to an example embodiment.

FIG. 6 is a schematic diagram of an information receiving method according to an example embodiment.

FIG. 7 is a schematic diagram of an information receiving method according to an example embodiment.

FIG. 8 is a schematic diagram of an information receiving method according to an example embodiment.

FIG. 9 is a schematic diagram of an information receiving method according to an example embodiment.

FIG. 10 is a schematic diagram of an information reporting device according to an example embodiment.

FIG. 11 is a schematic diagram of an information reporting device according to an example embodiment.

FIG. 12 is a schematic diagram of a structure of a terminal according to an example embodiment.

FIG. 13 is a block diagram of a base station according to an example embodiment.

### DETAILED DESCRIPTION

Here, example embodiments will be described in detail, examples of which are shown in the accompanying drawings. When the following description refers to the drawings, unless otherwise indicated, the same numbers in different drawings represent the same or similar elements. The embodiments described in the following example embodiments do not represent all embodiments consistent with the embodiments of the present disclosure. Instead, they are only examples of devices and methods consistent with some aspects of the embodiments of the present disclosure as detailed in the attached claims.

The terms used in the embodiments of the present disclosure are only for the purpose of describing specific embodiments and are not intended to limit the embodiments of the present disclosure. The singular forms “a”, “an” and “the” used in the embodiments of the present disclosure and the attached claims are also intended to include the plural forms unless the context clearly indicates other meanings. It should also be understood that the term “and/or” used herein refers to and includes any or all possible combinations of one or more associated listed items.

It should be understood that although the terms first, second, third, etc. may be used in the embodiments of the present disclosure to describe various information, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein can be interpreted as “upon” or “when” or “in response to determining”.

For the purpose of simplicity and ease of understanding, the terms used herein to characterize the size relationship are “greater than” or “less than”. However, for those skilled in the art, it can be understood that the term “greater than” also covers the meaning of “greater than or equal to”, and “less than” also covers the meaning of “less than or equal to”.

Please refer to FIG. 1, which shows a structural schematic diagram of a wireless communication system provided by an embodiment of the present disclosure. As shown in FIG. 1, the wireless communication system is a communication system based on mobile communication technology, and the wireless communication system may include several user equipment 110 and several base stations 120.

The user equipment 110 may be a device that provides voice and/or data connectivity to the user. The user equipment 110 may communicate with one or more core networks via a radio access network (RAN), and the user equipment 110 may be an Internet of Things user equipment, such as a sensor device, a mobile phone, and a computer with an Internet of Things user equipment. For example, the computer with an Internet of Things user equipment may be a fixed, portable, pocket-sized, handheld, computer-built-in or vehicle-mounted device. For example, it may be a station (STA), a subscriber unit, a subscriber station, a mobile station, mobile, a remote station, an access point, a remote terminal, an access terminal, a user terminal, a user agent, a user device, or user equipment. Alternatively, the user equipment 110 may also be a device of an unmanned aerial vehicle. Alternatively, the user equipment 110 may also be a vehicle-mounted device, for example, a driving computer with wireless communication function, or a wireless user equipment connected to an external driving computer. Alternatively, the user equipment 110 may also be a roadside device, for example, a street lamp, a signal lamp or other roadside device with wireless communication function. It should be noted that the user equipment (UE) in the present disclosure may be a terminal.

The base station 120 may be a network-side device in a wireless communication system. The wireless communication system may be a 4th generation mobile communication technology (4G) system, also known as a long term evolution (LTE) system; or, the wireless communication system may be a 5G system, also known as a new radio system or a 5G NR system. Alternatively, the wireless communication system may be a next generation system of the 5G system. The access network in the 5G system may be referred to as NG-RAN (New Generation-Radio Access Network).

The base station 120 may be an evolved base station (eNB) used in a 4G system. Alternatively, the base station 120 may also be a base station (gNB) using a centralized distributed architecture in a 5G system. When the base station 120 uses a centralized distributed architecture, it generally includes a central unit (CU) and at least two distributed units (DU). The central unit is provided with a protocol stack of a packet data convergence protocol (PDCP) layer, a radio link control (RLC) layer, and a media access control (MAC) layer; the distributed unit is provided with a physical (PHY) layer protocol stack. The specific implementation method of the base station 120 is not limited in the embodiment of the present disclosure.

A wireless connection can be established between the base station 120 and the user equipment 110 through a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new radio; or, the wireless air interface can also be a wireless air interface based on the next generation mobile communication network technology standard of 5G.

In some embodiments, an E2E (End to End) connection can also be established between the user equipment 110 in the scenarios such as V2V (vehicle to vehicle) communication, V2I (vehicle to infrastructure) communication, V2P (vehicle to pedestrian) communication in vehicle to everything (V2X) communication, etc.

Here, the user equipment can be considered as the terminal device of the following embodiments.

In some embodiments, the wireless communication system can further include a network management device 130.

Several base stations 120 are respectively connected to the network management device 130. The network management device 130 can be a core network device in the wireless communication system. For example, the network management device 130 can be a mobility management entity (MME) in the evolved packet core (EPC). Alternatively, the network management device may also be other core network devices, such as a Serving GateWay (SGW), a Public Data Network GateWay (PGW), a Policy and Charging Rules Function (PCRF), or a Home Subscriber Server (HSS), etc. The implementation form of the network management device 130 is not limited in the embodiments of the present disclosure.

In order to facilitate the understanding of those skilled in the art, the embodiments of the present disclosure list multiple implementations to clearly illustrate the technical solutions of the embodiments of the present disclosure. Of course, those skilled in the art can understand that the multiple embodiments provided in the embodiments of the present disclosure can be executed separately, or can be executed together with the methods of other embodiments in the embodiments of the present disclosure, or can be executed separately or in combination with some methods in other related technologies; the embodiments of the present disclosure do not limit this.

In order to better understand the embodiments of the present disclosure, the following describes the relevant scenarios of CSI compression, where CSI compression can also be understood as CSI encoding:

In an embodiment, with a certain input dimension of the AI model used for CSI compression (i.e., with a certain amount of the channel information to be compressed), different numbers of compressed output bits will affect the final performance. Here, the number of channel information to be compressed=the number of base station antenna ports× the number of sub-bands.

Through simulation results, it is found that as the number of output bits increases, the compression performance of the AI model used for CSI compression is better.

In one embodiment, in codebook-based CSI feedback, for example, in eTypeII codebook-based CSI feedback, when the base station configures different feedback parameters, as the feedback overhead increases, the performance of eTypeII also increases.

In one embodiment, for codebook-based CSI feedback, for example, eTypeII codebook-based CSI feedback, all terminals use the same codebook algorithm. Therefore, when the feedback parameters configured by the base station are the same, the channel accuracy fed back by different terminals is the same. However, for AI-based CSI feedback, in the case of separate training, the implementation of the encoder depends on the implementation of respective terminals. Therefore, even if the feedback overhead is the same, some terminals may have better encoder performance and some terminals may have worse encoder performance. In order to ensure performance fairness, terminals with worse encoders may require higher CSI feedback overhead to improve the recovered channel accuracy.

In one embodiment, during the CSI feedback process, CSI can be encoded by an artificial intelligence (AI) model. In the process of encoding CSI by the AI model, overhead parameters need to be used. At this time, it is necessary to consider obtaining the smallest possible overhead and ensuring channel accuracy.

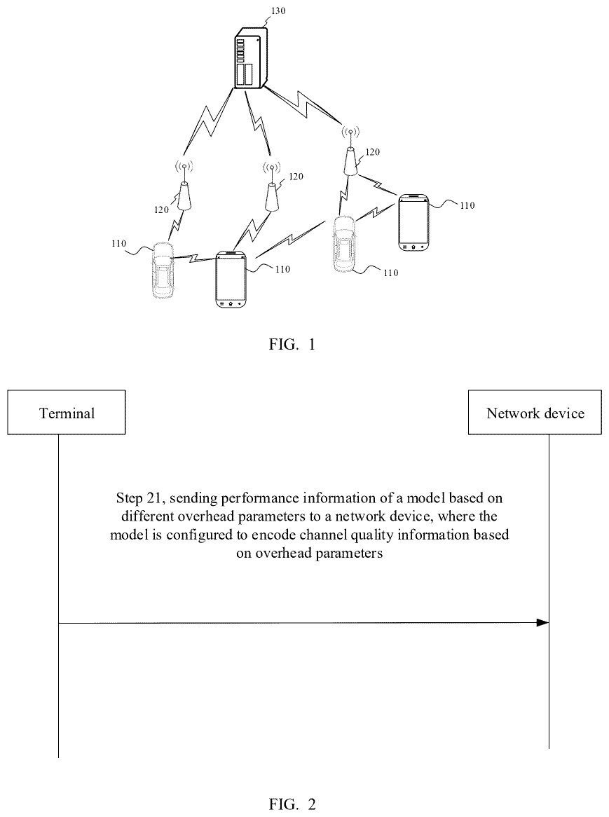

As shown in FIG. 2, this embodiment provides an information reporting method, where the method is performed by a terminal, and the method includes:

Step 21, sending performance information of a model based on different overhead parameters to a network device;

where the model is configured to encode channel quality information based on overhead parameters.

In one embodiment, the performance information of the model based on different overhead parameters is sent to the network device; where the model is configured to encode channel quality information based on the overhead parameters during channel quality information feedback.

In one embodiment, the performance information is configured to determine a first overhead parameter from the overhead parameters.

Here, the terminal involved in the present disclosure may be, but is not limited to, a mobile phone, a wearable device, a vehicle-mounted terminal, a road side unit (RSU), a smart home terminal, an industrial sensor device and/or a medical device. In some embodiments, the terminal may be a Redcap terminal or a predetermined version of a new radio NR terminal (e.g., an R17 NR terminal).

The network device involved in the present disclosure may be a base station, which may be various types of base stations, such as a base station of a third generation mobile communication (3G) network, a base station of a fourth generation mobile communication (4G) network, a base station of a fifth generation mobile communication (5G) network, or other evolved base stations. The network device may also be a core network device, which may be various physical network unit entities or logical network units, such as an access and mobility management function (AMF) and a location management function (LMF).

In the present disclosure, the model may be an AI model, such as a machine learning (ML) model.

In the present disclosure, encoding may be but is not limited to compression and/or quantization operations.

In the present disclosure, the channel quality information may be information that can reflect the channel quality of communication between the terminal and the base station. The base station may determine the communication parameters for communication between the terminal and the base station based on the channel quality information.

In the present disclosure, the overhead parameter may be the value of the overhead parameter.

In one embodiment, based on different overhead parameters, the channel quality information obtained from the same channel measurement is encoded at least twice using the model. Performance information determined based on at least two encodings is sent to the network device.

In one embodiment, the performance information of the model based on different overhead parameters is sent to the network device; where the model is configured to encode the channel quality information based on the overhead parameters; the performance information is determined by the performance parameters of the model.

In one embodiment, the performance information may further include source channel quality information before encoding. In this way, after decompressing the encoded channel quality information reported by the terminal, the base station compares the decompressed channel quality information with the source channel quality information to determine the performance of the model.

In one embodiment, the performance information of the model based on different overhead parameters is sent to the network device; where the model is configured to encode channel quality information based on overhead parameters; the performance information is determined by the performance parameters of the model; the performance parameters include the performance metric of the model and the corresponding overhead parameters for encoding the channel quality information.

Here, the performance metric is a parameter for measuring the performance of the model.

In one embodiment, the performance metric of the model includes at least one of:
Square of Generalized cosine similarity (SGCS);
Normalized Mean Squared Error (NMSE);
spectrum efficiency; and Signal to Noise Ratio (SNR).

In one embodiment, the performance information of the model based on different overhead parameters is sent to a network device; where the model is configured to encode channel quality information based on overhead parameters; the performance parameters include the square of cosine similarity SGCS of the model and the corresponding overhead parameters for encoding the channel quality information, where the overhead parameters can also be understood as payload.

It should be noted that the model can be at least two different compression models from different terminals, for example, model A and model B.

For example, for the case where the model is model A, the performance parameters can correspond to:

$$\{ SGCS = 0.8 , payload = 100 bit \} ;$$

$$\{ SGCS = 0.9 , payload = 150 bit \} .$$

For example, for the case where the model is model B, the performance parameters can correspond to:

$$\{ SGCS = 0.8 , payload = 120 bit \} ;$$

$$\{ SGCS = 0.9 , payload = 200 bit \} .$$

It should be noted that the payload can be the number of bits of feedback, but the payload is not necessarily the direct number of feedback bits, and may also be the number of information dimensions before quantization. The base station can determine the specific feedback overhead parameter by the payload and other parameters. For example, the feedback overhead parameter is obtained by calculating the quantization parameter.

In one embodiment, the performance information of the model based on different overhead parameters is sent to the network device; where the model is configured to encode channel quality information based on overhead parameters; the performance information includes the normalized mean square error NMSE of the model and the corresponding overhead parameter for encoding the channel quality information.

In the above example, the performance parameter actually directly indicates the performance of the model. After receiving the performance parameter, the base station can directly determine the performance of the model based on the performance parameter, and configure a reasonable channel quality information reporting overhead (i.e., the first overhead parameter) for the terminal based on the performance of the model.

In one embodiment, the performance information of the model based on different overhead parameters is sent to the network device; where the model is configured to encode channel quality information based on overhead parameters. The performance information indication is determined by the model type information of the model, and the model type information corresponds to predetermined information. The predetermined information indicates at least one of: performance parameters of the model; training mode of the model; training time of the model; and training batch of the model. Here, the performance information may further include source channel quality information before encoding.

Here, the model type information may be the name of the model.

For example, if the name of the model is “A”, the corresponding training mode is the first training mode, the training time is the first training time, and the training batch is the first training batch.

If the name of the model is “B”, the corresponding training mode is the second training mode, the training time is the second training time, and the training batch is the second training batch.

In this way, after determining the name of the model, the base station can determine the corresponding training mode, training time, and training batch based on the mapping relationship, which is stored locally, between the model type information and the predetermined information.

In one embodiment, the performance information of the model based on different overhead parameters is sent to the network device; where the model is configured to encode channel quality information based on the overhead parameters; and the performance information is determined by the encoding result of the model. Here, the performance information may further include source channel quality information before being encoded. In this way, after the channel quality information is decompressed, the performance of the model can be determined based on the source channel quality information and the decompression result.

In one embodiment, the performance information of the model based on different overhead parameters is sent to the network device; where the model is configured to encode channel quality information based on overhead parameters; the performance information is determined by the encoding result of compressing the channel quality information by the model. The encoding result includes at least two encoding results obtained by encoding the channel quality information obtained in the same channel measurement process by different overhead parameters. Here, the performance information may further include source channel quality information before being encoded. In this way, after the channel quality information is decompressed, the performance of the model can be determined based on the source channel quality information and the encoding result.

In one embodiment, the report configuration information sent by the network device is received; where the report configuration information indicates that the network device requires the terminal to report the performance information of the channel quality information encoded by at least one overhead parameter; the network device requires the terminal to report the source channel quality information before encoding; the network device requires the terminal to report model type information; and the overhead parameters recommended by the network device for compressing the channel quality information by the model. The encoding result of compressing the channel quality information based on the overhead parameters is used to be reported to the network device. Based on the report configuration information, the performance information of the model is sent to the network device. The model is configured to encode channel quality information based on overhead parameters during the channel quality information feedback process; and the performance information is used to determine the first overhead parameter from the overhead parameters.

In one embodiment, the performance information of the model based on different overhead parameters is sent to the network device; where the model is configured to encode channel quality information based on overhead parameters. The performance information is determined by the performance information of the model encoding channel quality information based on different overhead parameters.

In one embodiment, the performance information of the model based on different overhead parameters is sent to the network device; where the model is configured to encode channel quality information based on overhead parameters. Control information sent by the network device is received, where the control information carries the first overhead parameter. In the channel quality information feedback process, the channel quality information is compressed by the model based on the first overhead parameter.

In one embodiment, the performance information of the model based on different overhead parameters is sent to the network device; where the model is configured to encode channel quality information based on overhead parameters. Control information sent by the network device is received, where the control information indicates the first overhead parameter. In the channel quality information feedback process, the channel quality information is compressed by the model based on the first overhead parameter.

In one embodiment, the channel quality information may be CSI. Of course, it is not limited to CSI, and may also be other information reflecting channel quality, such as channel eigenvector information, precoding matrix indication information, frequency domain-spatial domain full channel information, angle-delay domain full channel information, etc.

In the embodiment of the present disclosure, the performance information of the model based on different overhead parameters is sent to the network device; where the model is configured to encode channel quality information based on overhead parameters. Here, since the terminal sends the performance information to the network device, after receiving the performance information, the network device can determine the first overhead parameter for compressing the channel quality information by the model based on the performance information. Compared with the method of arbitrarily determining the overhead parameter for compressing the channel quality information by the model, it can adapt to the performance of the model, so that a balance can be achieved between overhead and performance to ensure channel accuracy.

It should be noted that those skilled in the art can understand that the method provided in the embodiment of the present disclosure can be executed alone or together with some methods in the embodiment of the present disclosure or some methods in related art. The optional examples in the same embodiment can be combined with each other, and the optional examples can be referred to each other between different embodiments. The embodiments can be combined with each other when there is no contradiction, and the steps can be exchanged in order when there is no contradiction.

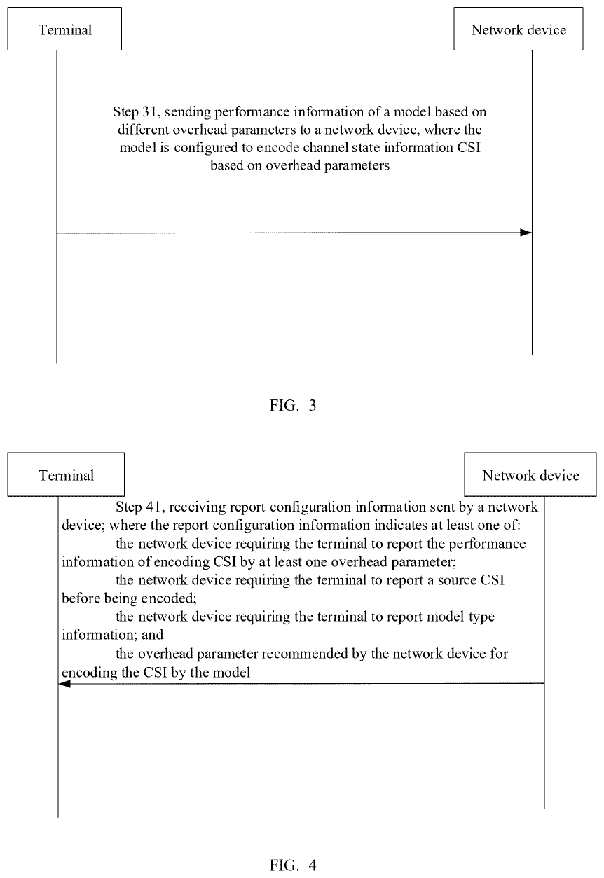

As shown in FIG. 3, an information reporting method is provided in this embodiment, where the method is performed by a terminal, and the method includes:

Step 31, sending performance information of a model based on different overhead parameters to a network device;

where the model is configured to encode channel state information CSI based on overhead parameters.

In one embodiment, the performance information of the model based on different overhead parameters is sent to the network device; where the model is configured to encode CSI based on the overhead parameters during channel quality information feedback.

In one embodiment, the performance information is used to determine a first overhead parameter from the overhead parameters.

Here, the terminal involved in the present disclosure may be, but is not limited to, a mobile phone, a wearable device, a vehicle-mounted terminal, a road side unit (RSU, Road Side Unit), a smart home terminal, an industrial sensor device and/or a medical device, etc. In some embodiments, the terminal may be a Redcap terminal or a predetermined version of a new radio NR terminal (for example, an NR terminal of R17).

The network device involved in the present disclosure may be a base station, and the base station may be various types of base stations, for example, a base station of a third generation mobile communication (3G) network, a base station of a fourth generation mobile communication (4G) network, a base station of a fifth generation mobile communication (5G) network, or other evolved base stations. The network device may also be a core network device, and the core network device may be various physical network unit entities or logical network units, for example, an access and mobility management function (AMF) and a location management function (LMF).

In the present disclosure, the model may be a machine learning (ML) model.

In the present disclosure, the encoding may be, but is not limited to, compression and/or quantization operations.

In the present disclosure, the CSI may be information that can reflect the channel quality of communication between the terminal and the base station. The base station may determine the communication parameters for communication between the terminal and the base station based on the CSI.

In the present disclosure, the overhead parameter may be the value of the overhead parameter.

In one embodiment, based on different overhead parameters, the CSI obtained by the same channel measurement is encoded at least twice using the model. Performance information determined based on at least two encodings is sent to the network device.

In one embodiment, the performance information of the model based on different overhead parameters is sent to the network device; where the model is configured to encode the channel state information CSI based on the overhead parameters; and the performance information is determined by the performance parameters of the model.

In one embodiment, the performance information may further include source CSI before encoding. In this way, after decompressing the encoded CSI reported by the terminal, the base station compares the decompressed CSI with the source CSI to determine the performance of the model.

In one embodiment, the performance information of the model based on different overhead parameters is sent to the network device; where the model is configured to encode the channel state information CSI based on overhead parameters; the performance information is determined by the performance parameters of the model; the performance parameters include the performance metric of the model and the corresponding overhead parameters for encoding the CSI. In one embodiment, the performance metric of the model includes at least one of:

Square of Generalized cosine similarity SGCS;

Normalized Mean Squared Error NMSE;

spectrum efficiency; and

### Signal to Noise Ratio SNR.

In one embodiment, the performance information of the model based on different overhead parameters is sent to the network device; where the model is configured to encode the channel state information CSI based on overhead parameters; the performance parameters include the square of cosine similarity SGCS of the model and the corresponding overhead parameters for encoding the CSI, where the overhead parameters can also be understood as payload.

It should be noted that the model can be at least two different compression models from different terminals, for example, model A and model B.

For example, for the case where the model is model A, the performance parameters may correspond to:

$$\{ SGCS = 0.8 , payload = 100 bit \} ;$$

$$\{ SGCS = 0.9 , payload = 150 bit \} .$$

For example, for the case where the model is model B, the performance parameters may correspond to:

$$\{ SGCS = 0.8 , payload = 120 bit \} ;$$

$$\{ SGCS = 0.9 , payload = 200 bit \} .$$

It should be noted that the payload may be the number of bits of feedback, but the payload is not necessarily the direct number of bits of feedback, and may also be the number of information dimensions before quantization. The base station can determine the specific feedback overhead parameter by the payload and other parameters. For example, the feedback overhead parameter is obtained by calculating the quantization parameter.

In one embodiment, the performance information of the model based on different overhead parameters is sent to the network device; where the model is configured to encode the channel state information CSI based on overhead parameters; the performance parameters include the normalized mean square error NMSE of the model and the corresponding overhead parameters for encoding the CSI.

In the above example, the performance parameters actually directly indicate the performance of the model. After receiving the performance parameters, the base station can directly determine the performance of the model based on the performance parameter, and configure a reasonable CSI reporting overhead (i.e., the first overhead parameter) for the terminal based on the performance of the model.

In one embodiment, the performance information of the model based on different overhead parameters is sent to the network device; where the model is configured to encode the channel state information CSI based on overhead parameters. The performance information indication is determined by the model type information of the model, and the model type information corresponds to predetermined information. The predetermined information indicates at least one of: performance parameters of the model; training mode of the model; training time of the model; and training batch of the model. Here, the performance information may further include source channel quality information before being encoded.

Here, the model type information may be the name of the model.

For example, if the name of the model is “A”, the corresponding training mode is the first training mode, the training time is the first training time, and the training batch is the first training batch.

If the name of the model is “B”, the corresponding training mode is the second training mode, the training time is the second training time, and the training batch is the second training batch.

In this way, after determining the name of the model, the base station can determine the corresponding training mode, training time, and training batch based on the mapping relationship, which is stored locally, between the model type information and the predetermined information.

In one embodiment, the performance information of the model based on different overhead parameters is sent to the network device; where the model is configured to encode the channel state information CSI based on the overhead parameters; and the performance information is determined by the encoding result of the model. Here, the performance information may further include the source CSI before encoding. In this way, after the encoded CSI is decompressed, the performance of the model can be determined based on the source CSI and the decompression result.

In one embodiment, the performance information of the model based on different overhead parameters is sent to the network device; where the model is configured to encode the channel state information CSI based on overhead parameters. The performance information is indicated by the encoding result of the model. The encoding result includes at least two encoding results obtained by encoding the CSI obtained in the same channel measurement process by different overhead parameters. Here, the performance information may further include the source CSI before encoding. In this way, after the CSI is decompressed, the performance of the model can be determined based on the source CSI and the decompression result.

In one embodiment, the report configuration information sent by the network device is received; where the report configuration information indicates that the network device requires the terminal to report the performance information of encoding CSI by at least one overhead parameter; the network device requires the terminal to report the source CSI before being encoded; the network device requires the terminal to report model type information; and the overhead parameters recommended by the network device for encoding the CSI by the model. The performance information of the model is sent to the network device based on the report configuration information. The model is configured to compress CSI based on overhead parameters during the CSI feedback process; and the performance information is used to determine the first overhead parameter from the overhead parameters.

In one embodiment, the performance information based on different overhead parameters of the model is sent to the network device; where the model is configured to perform encoding of the channel state information CSI based on the overhead parameters; the performance information is used to determine a first overhead parameter from the overhead parameters; the performance information is determined by the performance information of the model compressing CSI based on different overhead parameters.

In one embodiment, the performance information based on different overhead parameters of the model is sent to the network device; where the model is configured to perform encoding of channel state information CSI based on overhead parameters. Control information sent by the network device is received, where the control information carries the first overhead parameter. In the CSI feedback process, CSI is compressed by the model based on the first overhead parameter.

In one embodiment, the performance information of the model based on different overhead parameters is sent to the network device; where the model is configured to perform encoding of channel state information CSI based on overhead parameters. Control information sent by the network device is received, where the control information indicates the first overhead parameter. In the CSI feedback process, CSI is compressed by the model based on the first overhead parameter.

In the embodiment of the present disclosure, the performance information of the model based on different overhead parameters is sent to the network device; where the model is configured to perform encoding of channel state information CSI based on overhead parameters. Here, since the terminal sends the performance information to the network device, after receiving the performance information, the network device can determine the first overhead parameter for compressing the CSI by the model based on the performance information. Compared with the method of arbitrarily determining the overhead parameter for compressing the CSI by the model, it can adapt to the performance of the model, so that a balance can be achieved between overhead and performance to ensure channel accuracy.

It should be noted that those skilled in the art can understand that the method provided in the embodiment of the present disclosure can be executed alone or together with some methods in the embodiment of the present disclosure or some methods in related art. The optional examples in the same embodiment can be combined with each other, and the optional examples can be referred to each other between different embodiments. The embodiments can be combined with each other when there is no contradiction, and the steps can be exchanged in order when there is no contradiction.

As shown in FIG. 4, the present embodiment provides an information reporting method, where the method is performed by a terminal, and the method includes:

Step 41, receiving report configuration information sent by a network device; where the report configuration information indicates at least one of:

the network device requiring the terminal to report the performance information of encoding CSI by at least one overhead parameter;

the network device requiring the terminal to report a source CSI before being encoded;

the network device requiring the terminal to report model type information; and

the overhead parameter recommended by the network device for encoding the CSI by the model.

In one embodiment, the encoding result of encoding the CSI based on the overhead parameter is reported to the network device.

In one embodiment, the report configuration information sent by the network device is received; where the report configuration information indicates at least one of: the network device requiring the terminal to report the performance information of encoding the CSI by at least one overhead parameter; the network device requiring the terminal to report the source CSI before being encoded; the network device requiring the terminal to report model type information; and the overhead parameters recommended by the network device for encoding the CSI by the model. Correspondingly, after the report configuration information being received, at least one of the information is reported: the performance information of encoding the CSI by at least one overhead parameter, the information of the source CSI before being encoded, and the model name.

In one embodiment, the report configuration information sent by the network device is received; where the report configuration information indicates that the network device requires the terminal to report the performance information of encoding the CSI by at least one overhead parameter; the network device requires the terminal to report the source CSI before being encoded; the network device requires the terminal to report model type information; and the overhead parameters recommended by the network device for encoding the CSI by the model. The performance information of the model is sent to the network device based on the report configuration information; where the model is configured to encode the channel state information CSI based on the overhead parameter in the CSI feedback process. The performance information is used to determine the first overhead parameter from the overhead parameters. The performance information includes the performance information of encoding the CSI by at least one overhead parameter, the information of the source CSI before being encoded, and the model name.

It should be noted that those skilled in the art can understand that the method provided in the embodiment of the present disclosure can be executed alone or together with some methods in the embodiment of the present disclosure or some methods in related art. The optional examples in the same embodiment can be combined with each other, and the optional examples can be referred to each other between different embodiments. The embodiments can be combined with each other when there is no contradiction, and the steps can be exchanged in order when there is no contradiction.

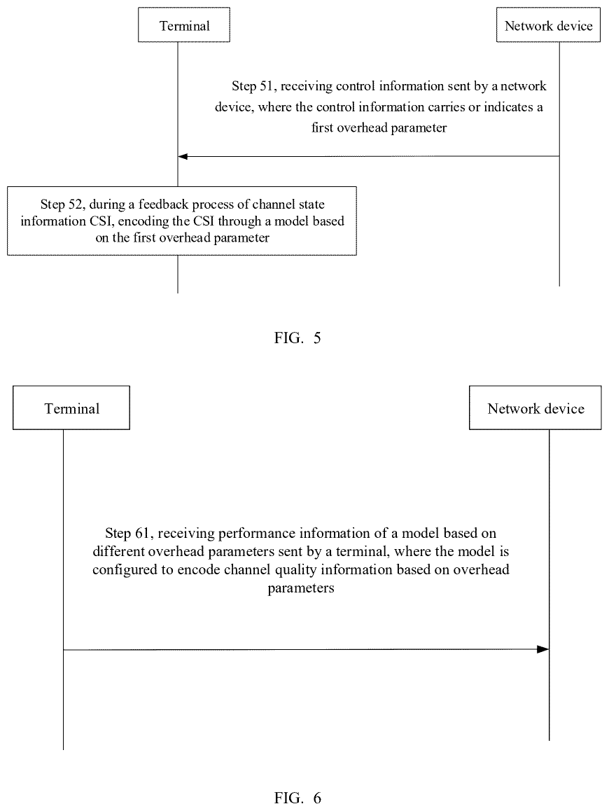

As shown in FIG. 5, the present embodiment provides an information reporting method, where the method is performed by a terminal, and the method includes:

Step 51, receiving control information sent by a network device, where the control information carries or indicates a first overhead parameter;

Step 52, during a feedback process of channel state information CSI, encoding the CSI through a model based on the first overhead parameter.

In one embodiment, the performance information of the model based on different overhead parameters is sent to the network device; where the model is configured to encode the channel state information CSI based on the overhead parameter. Control information sent by the network device is received, where the control information carries the first overhead parameter. In the CSI feedback process, CSI is compressed through the model based on the first overhead parameter.

In one embodiment, the performance information of the model based on different overhead parameters is sent to the network device; where the model is configured to encode the channel state information CSI based on the overhead parameter. Control information sent by the network device is received, where the control information carries the first overhead parameter. In the CSI feedback process, CSI is compressed through the model based on the first overhead parameter.

It should be noted that those skilled in the art can understand that the method provided in the embodiment of the present disclosure can be executed alone or together with some methods in the embodiment of the present disclosure or some methods in related art. The optional examples in the same embodiment can be combined with each other, and the optional examples can be referred to each other between different embodiments. The embodiments can be combined with each other when there is no contradiction, and the steps can be exchanged in order when there is no contradiction.

As shown in FIG. 6, an information receiving method is provided in this embodiment, where the method is performed by a network device, and the method includes:

Step 61, receiving performance information of a model based on different overhead parameters sent by a terminal;

where the model is configured to encode channel quality information based on overhead parameters.

In one embodiment, the performance information of the model based on different overhead parameters sent by the terminal is received; where the model is configured to encode channel quality information based on overhead parameters during the feedback process of the channel quality information.

In one embodiment, the performance information is used to determine the first overhead parameter from the overhead parameters.

Here, the terminal involved in the present disclosure may be, but is not limited to, a mobile phone, a wearable device, a vehicle-mounted terminal, a road side unit (RSU, Road Side Unit), a smart home terminal, an industrial sensor device and/or a medical device, etc. In some embodiments, the terminal may be a Redcap terminal or a predetermined version of a new radio NR terminal (for example, an R17 NR terminal).

The network device involved in the present disclosure may be a base station, and the base station may be various types of base stations, for example, a base station of a third generation mobile communication (3G) network, a base station of a fourth generation mobile communication (4G) network, a base station of a fifth generation mobile communication (5G) network, or other evolved base stations. The network device may also be a core network device, and the core network device may be various physical network unit entities or logical network units, for example, an access and mobility management function (AMF) and a location management function (LMF).

In the present disclosure, the model may be a machine learning (ML) model.

In the present disclosure, the encoding may be, but is not limited to, compression and/or quantization operations.

In the present disclosure, the channel quality information may be information that can reflect the channel quality of communication between the terminal and the base station. The base station may determine the communication parameters for communication between the terminal and the base station based on the channel quality information.

In the present disclosure, the overhead parameter may be the value of the overhead parameter.

In one embodiment, the performance information of the model based on different overhead parameters sent by the terminal is received; where the model is configured to encode channel quality information based on overhead parameters; the performance information is determined by the performance parameters for compressing the channel quality information by the model.

In one embodiment, the performance information may further include source channel quality information before being encoded. In this way, after decompressing the encoded channel quality information reported by the terminal, the base station compares the decompressed channel quality information with the source channel quality information to determine the performance of the model.

In one embodiment, the performance information of the model based on different overhead parameters sent by the terminal is received; where the model is configured to encode channel quality information based on overhead parameters. The performance information is determined by the performance parameters of encoding the channel quality information by the model. The performance parameters include the performance metric of the model and the corresponding overhead parameters for encoding the channel quality information.

In one embodiment, the performance metric of the model includes at least one of:
Square of Generalized cosine similarity (SGCS);
Normalized Mean Squared Error (NMSE);
spectrum efficiency (Spectrum efficiency) and Signal to Noise Ratio (SNR).

In one embodiment, the performance information of the model based on different overhead parameters sent by the terminal is received; where the model is configured to encode channel quality information based on overhead parameters. The performance parameters include the square of cosine similarity SGCS of the model and the corresponding overhead parameters for encoding the channel quality information, where the overhead parameters can also be understood as payload.

It should be noted that the model can be at least two different compression models from different terminals, for example, model A and model B.

For example, for the case where the model is model A, the performance parameters can correspond to:

$$\{ SGCS = 0.8 , payload = 100 bit \} ;$$

$$\{ SGCS = 0.9 , payload = 150 bit \} .$$

For example, for the case where the model is model B, the performance parameters may correspond to:

$$\{ SGCS = 0.8 , payload = 120 bit \} ;$$

$$\{ SGCS = 0.9 , payload = 200 bit \} .$$

It should be noted that the payload may be the number of bits of feedback, but the payload is not necessarily the number of direct feedback bits, and may also be the number of information dimensions before quantization. The base station may determine the specific feedback overhead parameter by the payload and other parameters. For example, the feedback overhead is obtained by calculating the quantization parameter.

In one embodiment, the performance information of the model based on different overhead parameters sent by the terminal is received; where the model is configured to encode channel quality information based on the overhead parameter. The performance parameter includes the normalized mean square error NMSE of the model and the corresponding overhead parameter for encoding the channel quality information.

In the above example, the performance parameter actually directly indicates the performance of the model. After receiving the performance parameter, the base station may directly determine the performance of the model based on the performance parameter, and configure a reasonable CSI reporting overhead (i.e., the first overhead parameter) for the terminal based on the performance of the model.

In one embodiment, the performance information of the model based on different overhead parameters sent by the terminal is received; where the model is configured to encode channel quality information based on overhead parameters. The performance information indication is determined by the model type information of the model, and the model type information corresponds to the predetermined information. The predetermined information indicates at least one of: performance parameters of the model; training mode of the model; training time of the model; and training batch of the model. Here, the performance information may further include source channel quality information before being encoded.

Here, the model type information may be the name of the model.

For example, if the name of the model is “A”, the corresponding training mode is the first training mode, the training time is the first training time, and the training batch is the first training batch.

If the name of the model is “B”, the corresponding training mode is the second training mode, the training time is the second training time, and the training batch is the second training batch.

In this way, after determining the name of the model, the base station can determine the corresponding training mode, training time, and training batch based on the mapping relationship, which is stored locally, between the model type information and the predetermined information.

In one embodiment, the performance information of the model based on different overhead parameters sent by the terminal is received; where the model is configured to encode channel quality information based on overhead parameters. The performance information is determined by the compression result of the model. Here, the performance information may further include source channel quality information before being encoded. In this way, after the channel quality information is decompressed, the performance of the model may be determined based on the source channel quality information and the decompression result.

In one embodiment, the performance information of the model based on different overhead parameters sent by the terminal is received; where the model is configured to encode channel quality information based on overhead parameters. The performance information is determined by the encoding result of the model. The encoding result includes at least two encoding results obtained by encoding the channel quality information obtained in the same channel measurement process by different overhead parameters. Here, the performance information may further include source channel quality information before being encoded. In this way, after the channel quality information is decompressed, the performance of the model may be determined based on the source channel quality information and the decompression result.

In one embodiment, the report configuration information is sent to a terminal; where the report configuration information indicates that the network device requires the terminal to report the performance information of encoding the CSI by at least one overhead parameter; the network device requires the terminal to report the source CSI before being encoded; the network device requires the terminal to report model type information; and the overhead parameters recommended by the network device for encoding the CSI by the model. The performance information of the model sent by the terminal based on the report configuration information is received; where the model is configured to encode channel quality information based on overhead parameters during the feedback process of the channel quality information. The performance information is used to determine a first overhead parameter from the overhead parameters.

In one embodiment, the performance information of the model based on different overhead parameters sent by the terminal is received; where the model is configured to encode channel quality information based on overhead parameters. The performance information is determined by the performance information of the model encoding channel quality information based on different overhead parameters.

In one embodiment, the performance information of the model based on different overhead parameters sent by the terminal is received; where the model is configured to encode channel quality information based on overhead parameters. Control information is sent to the terminal, where the control information carries the first overhead parameter. During the feedback process of the channel quality information, the terminal compresses the channel quality information by the model based on the first overhead parameter.

In one embodiment, the performance information of the model based on different overhead parameters sent by the terminal is received; where the model is configured to encode channel quality information based on overhead parameters. Control information is sent to the terminal, where the control information indicates a first overhead parameter. During feedback process of the channel quality information, the terminal compresses the channel quality information by the model based on the first overhead parameter.

In one embodiment, the performance information of the model based on different overhead parameters sent by the terminal is received; where the model is configured to encode channel quality information based on overhead parameters. The performance parameter of the model is determined based on the performance information. The first overhead parameter for compressing the channel quality information through the model is determined based on the performance parameter.

In one embodiment, the performance information of the model based on different overhead parameters sent by the terminal is received; where the model is configured to encode channel quality information based on overhead parameters. The performance parameter of the model is determined based on the performance information. The first overhead parameter for compressing the channel quality information through the model is determined based on the performance parameters and the correspondence between the performance parameters and the overhead parameters. It should be noted that the correspondence between the performance parameters and the overhead parameters can be stored locally in the access device.

In one embodiment, the channel quality information can be CSI. Of course, it is not limited to CSI, and can also be other information reflecting the channel quality, such as the characteristic vector information of the channel, the precoding matrix indication information, the frequency domain-spatial domain full channel information, the angle-delay domain full channel information, etc.

In the embodiment of the present disclosure, the performance information of the model based on different overhead parameters sent by the terminal is received; where the model is configured to encode the channel quality information based on the overhead parameters. Here, since the terminal sends the performance information to the network device, after receiving the performance information, the network device can determine the first overhead parameter for compressing the channel quality information by the model based on the performance information. Compared with the method of arbitrarily determining the overhead parameter for compressing the channel quality information by the model, it can adapt to the performance of the model, so that a balance can be achieved between overhead and performance to ensure channel accuracy.

It should be noted that those skilled in the art can understand that the method provided in the embodiment of the present disclosure can be executed alone or together with some methods in the embodiment of the present disclosure or some methods in related art. The optional examples in the same embodiment can be combined with each other, and the optional examples can be referred to each other between different embodiments. The embodiments can be combined with each other when there is no contradiction, and the steps can be exchanged in order when there is no contradiction.

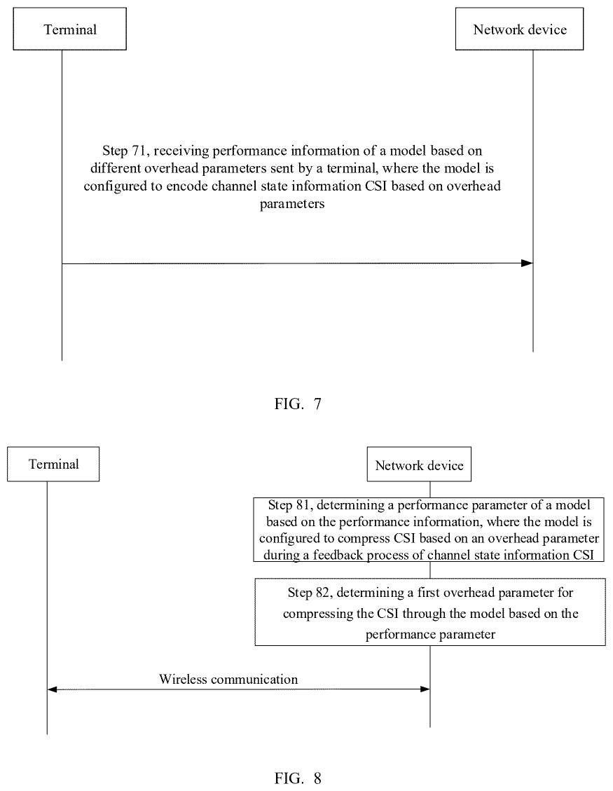

As shown in FIG. 7, an information receiving method is provided in this embodiment, where the method is performed by a network device, and the method includes:

Step 71, receiving performance information of a model based on different overhead parameters sent by a terminal;

where the model is configured to encode channel state information CSI based on overhead parameters.

In one embodiment, the performance information of the model based on different overhead parameters sent by the terminal is received; where the model is configured to encode CSI based on overhead parameters during the feedback process of the channel quality information.

In one embodiment, the performance information is used to determine a first overhead parameter from the overhead parameters.

Here, the terminal involved in the present disclosure may be, but is not limited to, a mobile phone, a wearable device, a vehicle-mounted terminal, a road side unit (RSU, Road Side Unit), a smart home terminal, an industrial sensor device and/or a medical device, etc. In some embodiments, the terminal may be a Redcap terminal or a predetermined version of a new radio NR terminal (for example, an NR terminal of R17).

The network device involved in the present disclosure may be a base station, and the base station may be various types of base stations, for example, a base station of a third generation mobile communication (3G) network, a base station of a fourth generation mobile communication (4G) network, a base station of a fifth generation mobile communication (5G) network, or other evolved base stations. The network device may also be a core network device, and the core network device may be various physical network unit entities or logical network units, for example, an access and mobility management function (AMF) and a location management function (LMF).

In the present disclosure, the model may be a machine learning (ML) model.

In the present disclosure, the encoding may be, but is not limited to, compression and/or quantization operations.

In the present disclosure, the CSI may be information that can reflect the channel quality of communication between the terminal and the base station. The base station may determine the communication parameters for communication between the terminal and the base station based on the CSI.

In the present disclosure, the overhead parameter may be the value of the overhead parameter.

In one embodiment, the performance information of the model based on different overhead parameters sent by the terminal is received; where the model is configured to encode CSI based on the overhead parameters. The performance information is determined by the performance parameters of the model.

In one embodiment, the performance information may further include the source CSI before being encoded. In this way, after decompressing the encoded CSI reported by the terminal, the base station compares the decompressed CSI with the source CSI to determine the performance of the model.

In one embodiment, the performance information of the model based on different overhead parameters sent by the terminal is received; where the model is configured to encode CSI based on overhead parameters. The performance information is determined by the performance parameters for compressing the CSI by the model. The performance parameters include the performance metric of the model and the corresponding overhead parameters for encoding the channel quality information.

In one embodiment, the performance metric of the model includes at least one of:
Square of Generalized cosine similarity (SGCS);
Normalized Mean Squared Error (NMSE);
spectrum efficiency; and
Signal to Noise Ratio (SNR).

In one embodiment, the performance information of the model based on different overhead parameters sent by the terminal is received; where the model is configured to encode CSI based on overhead parameters. The performance parameters include the square of cosine similarity SGCS of the model and the corresponding overhead parameters for encoding the channel quality information, where the overhead parameters can also be understood as payload.

It should be noted that the model can be at least two different compression models from different terminals, for example, model A and model B.

For example, for the case where the model is model A, the performance parameters may correspond to:

$$\{ SGCS = 0.8 , payload = 100 bit \} ;$$

$$\{ SGCS = 0.9 , payload = 150 bit \} .$$

For example, for the case where the model is model B, the performance parameters may correspond to:

$$\{ SGCS = 0.8 , payload = 120 bit \} ;$$

$$\{ SGCS = 0.9 , payload = 200 bit \} .$$

It should be noted that the payload may be the number of bits of feedback, but the payload is not necessarily the direct number of feedback bits, and may also be the number of information dimensions before quantization. The base station can determine the specific feedback overhead by the payload and other parameters. For example, the feedback overhead is obtained by calculating the quantization parameter.

In one embodiment, the performance information of the model based on different overhead parameters sent by the terminal is received; where the model is configured to encode CSI based on the overhead parameter. The performance parameter includes the normalized mean square error NMSE of the model and the corresponding overhead parameter for encoding the channel quality information.

In the above example, the performance parameter actually directly indicates the performance of the model. After receiving the performance parameter, the base station can directly determine the performance of the model based on the performance parameter, and configure a reasonable CSI reporting overhead (i.e., the first overhead parameter) for the terminal based on the performance of the model.

In one embodiment, the performance information of the model based on different overhead parameters sent by the terminal is received; where the model is configured to encode CSI based on the overhead parameter. The performance information indication is determined by the model type information of the model. The model type information corresponds to the predetermined information. The predetermined information indicates at least one of: the performance parameter of the model; the training mode of the model; the training time of the model; and the training batch of the model. Here, the performance information may further include the source CSI before compression.

Here, the model type information may be the name of the model.

For example, if the name of the model is “A”, the corresponding training mode is the first training mode, the training time is the first training time, and the training batch is the first training batch.

If the name of the model is “B”, the corresponding training mode is the second training mode, the training time is the second training time, and the training batch is the second training batch.

In this way, after determining the name of the model, the base station can determine the corresponding training mode, training time and training batch based on the mapping relationship, which is stored locally, between the model type information and the predetermined information.

In one embodiment, the performance information of the model based on different overhead parameters sent by the terminal is received; where the model is configured to encode CSI based on overhead parameters. The performance information is determined by the encoding result of the model. Here, the performance information may further include the source CSI before being encoded. In this way, after the encoded CSI is decompressed, the performance of the model can be determined based on the source CSI and the decompression result.

In one embodiment, the performance information of the model based on different overhead parameters sent by the terminal is received; where the model is configured to encode CSI based on overhead parameters. The performance information is indicated by the encoding result of encoding the CSI by the model. The encoding result includes at least two encoding results obtained by encoding the CSI obtained in the same channel measurement process by different overhead parameters. Here, the performance information may further include the source CSI before being encoded. In this way, after the CSI is decompressed, the performance of the model can be determined based on the source CSI and the decompression result.

In one embodiment, report configuration information is sent to the terminal; where the report configuration information indicates that the network device requires the terminal to report the performance information of encoding CSI by at least one overhead parameter; the network device requires the terminal to report the source CSI before being encoded; the network device requires the terminal to report model type information; and the overhead parameter recommended by the network device for encoding the CSI by the model. The performance information of the model sent by the terminal based on the report configuration information is received; where the model is configured to encode CSI based on overhead parameters in the CSI feedback process. The performance information is used to determine the first overhead parameter from the overhead parameters. The performance information includes at least two encoding results corresponding to encoding CSI based on at least two overhead parameters of the same channel measurement, information of the source CSI before being encoded, and the model name.

In one embodiment, the performance information of the model based on different overhead parameters sent by the terminal is received; where the model is configured to encode CSI based on overhead parameters. The performance information is determined by the performance information of the model encoding CSI based on different overhead parameters.

In one embodiment, the performance information of the model based on different overhead parameters sent by the terminal is received; where the model is configured to encode CSI based on overhead parameters. Control information is sent to the terminal, where the control information carries the first overhead parameter. In the CSI feedback process, the terminal compresses the CSI through the model based on the first overhead parameter.

In one embodiment, the performance information of the model based on different overhead parameters sent by the terminal is received; where the model is configured to encode CSI based on overhead parameters. Control information is sent to the terminal, where the control information indicates the first overhead parameter. In the CSI feedback process, the terminal compresses the CSI through the model based on the first overhead parameter.

In one embodiment, the performance information of the model based on different overhead parameters sent by the terminal is received; where the model is configured to encode CSI based on overhead parameters. The performance parameter of the model is determined based on the performance information. The first overhead parameter for compressing CSI through the model is determined based on the performance parameter.

In one embodiment, the performance information of the model based on different overhead parameters sent by the terminal is received; where the model is configured to encode CSI based on overhead parameters. The performance parameter of the model is determined based on the performance information. The first overhead parameter for compressing CSI through the model is determined based on the performance parameter, and the corresponding relationship between the performance parameter and the overhead parameter. It should be noted that the corresponding relationship between the performance parameter and the overhead parameter can be stored locally on the access device.

In the embodiment of the present disclosure, the performance information of the model based on different overhead parameters sent by the terminal is received; where the model is configured to encode CSI based on overhead parameters. Here, since the terminal sends the performance information to the network device, after receiving the performance information, the network device can determine the first overhead parameter for compressing CSI by the model based on the performance information. Compared with the method of arbitrarily determining the overhead parameter for the model compressing CSI, it can adapt to the performance of the model, so that a balance can be achieved between overhead and performance to ensure channel accuracy.

It should be noted that those skilled in the art can understand that the method provided in the embodiment of the present disclosure can be executed alone or together with some methods in the embodiment of the present disclosure or some methods in related art. The optional examples in the same embodiment can be combined with each other, and the optional examples can be referred to each other between different embodiments. The embodiments can be combined with each other when there is no contradiction, and the steps can be exchanged in order when there is no contradiction.

As shown in FIG. 8, this embodiment provides an information receiving method, where the method is performed by a network device, and the method includes:

Step 81, determining a performance parameter of a model based on the performance information, where the model is configured to compress CSI based on an overhead parameter during a feedback process of channel state information CSI;

Step 82, determining a first overhead parameter for compressing the CSI through the model based on the performance parameter.

In one embodiment, the performance information of the model based on different overhead parameters sent by the terminal is received; where the model is configured to encode CSI based on the overhead parameter. The performance parameter of the model can be determined based on the performance information, where the model is configured to compress the channel state information CSI based on the overhead parameter during the CSI feedback process. The first overhead parameter for compressing the CSI by the model is determined based on the performance parameter.

In one embodiment, the performance information of the model based on different overhead parameters sent by the terminal is received; where the model is configured to encode CSI based on the overhead parameters. The performance parameter of the model is determined based on the performance information, where the model is configured to compress the channel state information CSI based on the overhead parameter during the CSI feedback process. The first overhead parameter for compressing the CSI by the model is determined based on the performance parameter. The first overhead parameter is sent to the terminal. Here, control information can be sent to the terminal, where the control information carries or indicates the first overhead parameter.

It should be noted that those skilled in the art can understand that the method provided in the embodiment of the present disclosure can be executed alone or together with some methods in the embodiment of the present disclosure or some methods in related art. The optional examples in the same embodiment can be combined with each other, and the optional examples can refer to each other between different embodiments. The embodiments can be combined with each other when there is no contradiction, and the steps can be exchanged in order when there is no contradiction.

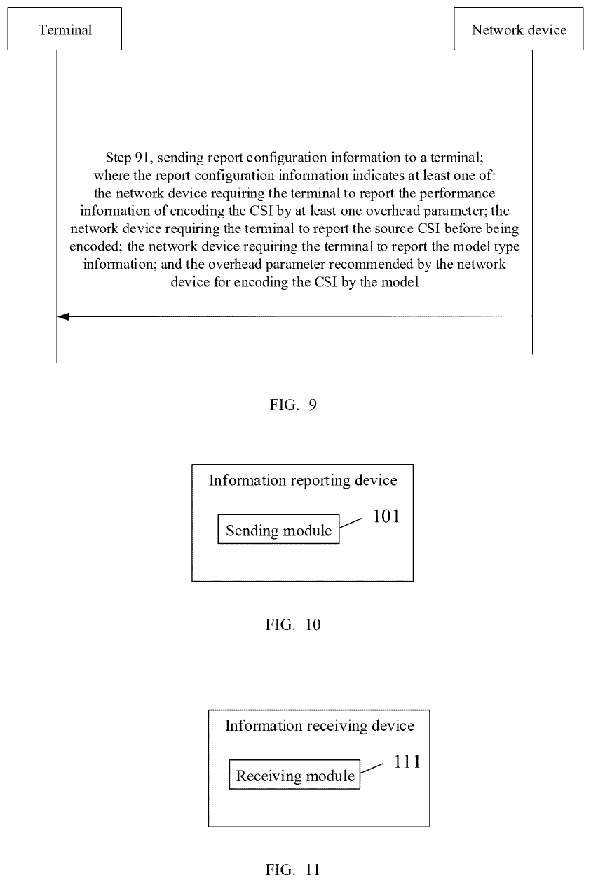

As shown in FIG. 9, an information receiving method is provided in this embodiment, where the method is performed by a network device, and the method includes:

Step 91, sending report configuration information to a terminal;

where the report configuration information indicates at least one of:

the network device requiring the terminal to report the performance information of encoding the CSI by at least one overhead parameter; the network device requiring the terminal to report the source CSI before being encoded; the network device requiring the terminal to report the model type information; and the overhead parameter recommended by the network device for encoding the CSI by the model.

In one embodiment, the encoding result of encoding the CSI based on the overhead parameter is reported to the network device.

In one embodiment, report configuration information is sent to the terminal; where the report configuration information indicates that the network device requires the terminal to report the performance information of encoding CSI by at least one overhead parameter; the network device requires the terminal to report the source CSI before being encoded; the network device requires the terminal to report model type information; and the overhead parameter recommended by the network device for encoding the CSI by the model. The performance information of the model sent by the terminal based on the report configuration information is received; where the model is configured to encode CSI based on the overhead parameter in the CSI feedback process. The performance information is used to determine the overhead parameter. The performance information includes the performance information of encoding CSI by at least one overhead parameter, the information of the source CSI before being encoded, and the model name.

It should be noted that those skilled in the art can understand that the method provided in the embodiment of the present disclosure can be executed alone or together with some methods in the embodiment of the present disclosure or some methods in the related art. The optional examples in the same embodiment can be combined with each other, and the optional examples can be referred to each other between different embodiments. The embodiments can be combined with each other when there is no contradiction, and the steps can be exchanged in order when there is no contradiction.

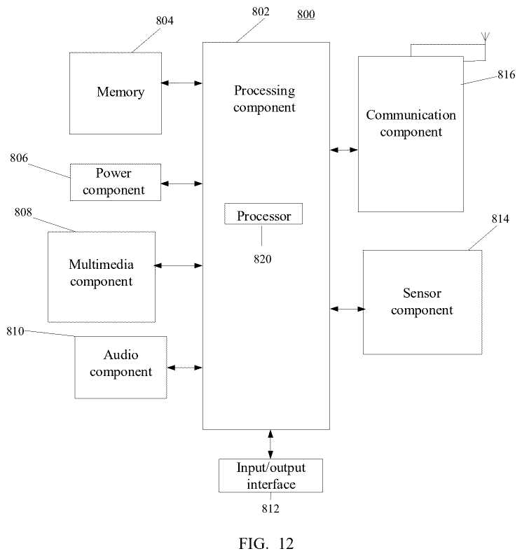

As shown in FIG. 10, an information reporting device is provided in an embodiment of the present disclosure, where the device includes:

a sending module 101 configured to send performance information of a model based on different overhead parameters to a network device;

where the model is configured to encode channel state information CSI based on an overhead parameter.

It should be noted that a person skilled in the art can understand that the method provided in the embodiment of the present disclosure can be executed alone or together with some methods in the embodiment of the present disclosure or some methods in related art. The optional examples in the same embodiment can be combined with each other, and the optional examples can refer to each other between different embodiments. When there is no contradiction, the embodiments can be combined with each other, and when there is no contradiction, the steps can be exchanged in order.

As shown in FIG. 11, an information reporting device is provided in an embodiment of the present disclosure, where the device includes:

a receiving module 111 configured to receive performance information of a model based on different overhead parameters sent by a terminal;

where the model is configured to encode channel state information CSI based on an overhead parameter.

It should be noted that a person skilled in the art can understand that the method provided in the embodiment of the present disclosure can be executed alone or together with some methods in the embodiment of the present disclosure or some methods in related art. The optional examples in the same embodiment can be combined with each other, and the optional examples can be referred to each other between different embodiments. The embodiments can be combined with each other when there is no contradiction, and steps can be exchanged in order when there is no contradiction.

The embodiment of the present disclosure provides a communication device. The communication device includes:
a processor;
a memory for storing processor executable instructions;
where the processor is configured to: implement the method applied to any embodiment of the present disclosure when running the executable instructions.
where the processor may include various types of storage media, which are non-transitory computer storage media, and can continue to store information stored thereon after the communication device is powered off.

The processor can be connected to the memory through a bus, etc., for reading the executable program stored on the memory.

The embodiment of the present disclosure also provides a computer storage medium, where the computer storage medium stores a computer executable program, and the executable program implements the method of any embodiment of the present disclosure when it is executed by the processor.

Regarding the device in the above embodiment, the specific way in which each module performs the operation has been described in detail in the embodiment of the method, and will not be explained in detail here.

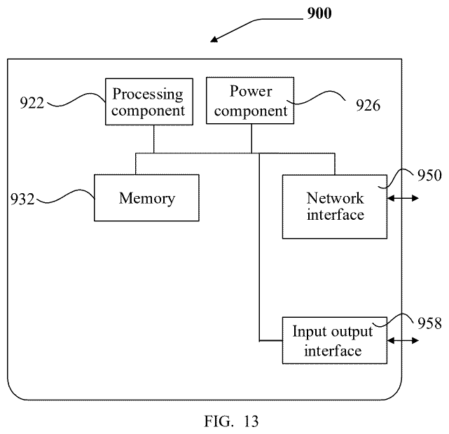

As shown in FIG. 12, an embodiment of the present disclosure provides a structure of a terminal.

Referring to the terminal 800 shown in FIG. 12, this embodiment provides a terminal 800, which may be a mobile phone, a computer, a digital broadcast terminal, a messaging device, a game console, a tablet device, a medical device, a fitness device, a personal digital assistant, etc.

Referring to FIG. 12, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of the terminal 800, such as operations associated with display, phone calls, data communications, camera operations, and recording operations. The processing component 802 may include one or more processors 820 to execute instructions to complete all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support the operation of the device 800. Examples of such data include instructions for any application or method operating on the terminal 800, contact data, phone book data, messages, pictures, videos, etc. The memory 804 can be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to various components of the terminal 800. The power component 806 may include a power management system, one or more power supplies, and other components associated with generating, managing and distributing power for the terminal 800.

The multimedia component 808 includes a screen that provides an output interface between the terminal 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor can sense not only the boundary of the touch or slide action, but also the duration and pressure associated with the touch or slide operation. In some embodiments, the multimedia component 808 includes a front camera and/or a rear camera. When the device 800 is in an operating mode, such as a shooting mode or a video mode, the front camera and/or the rear camera can receive external multimedia data. Each front camera and rear camera can be a fixed optical lens system or have focal length and optical zoom capabilities.

The audio component 810 is configured to output and/or input audio signals. For example, the audio component 810 includes a microphone (MIC), and when the terminal 800 is in an operating mode, such as a call mode, a recording mode, and a voice recognition mode, the microphone is configured to receive an external audio signal. The received audio signal can be further stored in the memory 804 or sent via the communication component 816. In some embodiments, the audio component 810 also includes a speaker for outputting audio signals.

The I/O interface 812 provides an interface between the processing component 802 and the peripheral interface module, which may be a keyboard, a click wheel, a button, etc. These buttons may include, but are not limited to, a home button, a volume button, a start button, and a lock button.

The sensor component 814 includes one or more sensors for providing various aspects of status assessment for the terminal 800. For example, the sensor component 814 can detect the open/closed state of the device 800, the relative positioning of components, such as the display and keypad of the terminal 800. The sensor component 814 can also detect the position change of the terminal 800 or a component of the terminal 800, the presence or absence of user contact with the terminal 800, the orientation or acceleration/deceleration of the terminal 800, and the temperature change of the terminal 800. The sensor component 814 may include a proximity sensor configured to detect the presence of nearby objects without any physical contact. The sensor component 814 may further include an optical sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 can access a wireless network based on a communication standard, such as Wi-Fi, 2G or 3G, or a combination thereof. In an example embodiment, the communication component 816 receives a broadcast signal or broadcast-related information from an external broadcast management system via a broadcast channel. In an example embodiment, the communication component 816 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an example embodiment, the terminal 800 can be implemented by one or more of an application-specific integrated circuit (ASIC), a digital signal processor (DSP), a digital signal processing device (DSPD), a programmable logic device (PLD), a field programmable gate array (FPGA), a controller, a microcontroller, a microprocessor or other electronic components to perform the above method.

In an example embodiment, a non-transitory computer-readable storage medium including instructions is also provided, such as a memory 804 including instructions, and the instructions can be executed by a processor 820 of a terminal 800 to complete the above method. For example, the non-transitory computer-readable storage medium can be a ROM, a random access memory (RAM), a CD-ROM, a tape, a floppy disk, and an optical data storage device, etc.

As shown in FIG. 13, an embodiment of the present disclosure shows a structure of a base station. For example, a base station 900 can be provided as a network-side device. Referring to FIG. 13, the base station 900 includes a processing component 922, which further includes one or more processors, and a memory resource represented by a memory 932 for storing instructions executable by the processing component 922, such as an application. The application stored in the memory 932 may include one or more modules each corresponding to a set of instructions. In addition, the processing component 922 is configured to execute instructions to execute the above method, and any method previously applied to the base station.

The base station 900 may further include a power component 926 configured to perform power management of the base station 900, a wired or wireless network interface 950 configured to connect the base station 900 to a network, and an input/output (I/O) interface 958. The base station 900 may operate based on an operating system stored in the memory 932, such as Windows Server™, Mac OS X™, Unix™, Linux™, FreeBSD™ or the like.

In order to better understand the embodiments of the present disclosure, the technical solution of the present disclosure is described below through an example embodiment:

### Example 1

In one embodiment, the terminal reports the performance of the AI model:
For example, the terminal reports the performance of the model directly,
For example, model A, {SGCS=0.8, payload=100 bit} {SGCS=0.9, payload=150 bit};
For example, model B, {SGCS=0.8, payload=120 bit} {SGCS=0.9, payload=200 bit};
In one embodiment, the terminal reports the performance of the model indirectly,
For example, reporting through the name of the AI model; type

For example, the name of the AI model contains the training mode, training time, training batch, etc., and the network can find the corresponding performance based on this information.

In one embodiment, the terminal reports the AI CSI compression result, and the network determines the AI model performance based on the AI CSI compression result.

For example, the network determines the performance of the current AI model based on the terminal's report, and the NW configures a set of CSI reports, which correspond to different CSI reporting overheads.

For example, the network configures different reporting bit numbers and corresponding original CSI, and then observes the SGCS performances under different CSI feedback overheads, and then configures a reasonable reporting overhead according to the results.

It should be noted that those skilled in the art can understand that the method provided in the embodiment of the present disclosure can be executed alone or together with some methods in the embodiment of the present disclosure or some methods in related art. The optional examples in the same embodiment can be combined with each other, and the optional examples can be referred to each other between different embodiments. The embodiments can be combined with each other when there is no contradiction, and the steps can be exchanged in order when there is no contradiction. After considering the specification and practicing the disclosure here, those skilled in the art will easily think of other implementation plans of the present disclosure. The present disclosure is intended to cover any variants, uses or adaptive changes of the present disclosure, which follow the general principles of the present disclosure and include common knowledge or conventional technical means in the technical field that are not disclosed in the present disclosure. The specification and embodiments are only regarded as exemplary, and the true scope and spirit of the present disclosure are indicated by the following claims.

It should be understood that the present disclosure is not limited to the precise structure described above and shown in the drawings, and various modifications and changes can be made without departing from its scope. The scope of the present disclosure is limited only by the accompanying claims.

1. A method for reporting information, performed by a terminal, comprising:
sending performance information of a model based on different overhead parameters to a network device;
wherein the model is configured to encode channel state information (CSI) based on the overhead parameters.

2. The method according to claim 1, further comprising: encoding the CSI obtained from a same channel measurement at least twice by using the model based on the different overhead parameters;
sending the performance information of the model based on the different overhead parameters to the network device comprises:
sending the performance information determined based on at least two encodings to the network device.

3. The method according to claim 1, further comprising:
receiving control information sent by the network device;
wherein the control information carries or indicates a first overhead parameter; the first overhead parameter is a parameter determined from the overhead parameters based on the performance information.

4. The method according to claim 1- or 2, wherein the performance information is determined by performance parameters of the model.

5. The method according to claim 4, wherein the performance parameters comprise a performance metric of the model and corresponding overhead parameters for encoding the CSI.

6. (canceled)

7. The method according to claim 1- or 2, wherein the performance information is determined by model type information of the model, and the model type information corresponds to predetermined information;
the predetermined information indicates at least one of:
performance parameters of the model;
model training mode;
model training time; and
model training batch.

8. The method according to claim 1- or 2, wherein the performance information is determined by encoding results of the model-, wherein the encoding results comprise at least two encoding results obtained by encoding the CSI obtained from a same channel measurement at least twice based on the different overhead parameters.

9. (canceled)

10. The method according to claim 1, further comprising:
receiving report configuration information sent by the network device; wherein the report configuration information indicates at least one of:
the network device requiring the terminal to report the performance information of encoding the CSI by at least one overhead parameter;
the network device requiring the terminal to report a source CSI before being encoded;
the network device requiring the terminal to report model type information; and
an overhead parameter recommended by the network device for encoding the CSI by the model.

11. A method for receiving information, performed by a network device, comprising:
receiving performance information of a model based on different overhead parameters sent by a terminal;
wherein the model is configured to encode channel state information CSI based on overhead parameters.

12. The method according to claim 11, wherein receiving the performance information of the model based on the different overhead parameters sent by the terminal comprises:
receiving the performance information determined based on at least two encodings sent by the terminal.

13. The method according to claim 11, further comprising:
determining performance parameters of the model based on the performance information.

14. The method according to claim 13, further comprising:
determining a first overhead parameter from the overhead parameters based on the performance parameters; and
sending control information to the terminal, wherein the control information carries the first overhead parameter.

15. The method according to claim 11, further comprising:
sending report configuration information to the terminal; wherein the report configuration information indicates at least one of: the network device requiring the terminal to report the performance information of compressing the CSI by at least one overhead parameter; the network device requiring the terminal to report a source CSI before being compressed; the network device requiring the terminal to report model type information; and the overhead parameters recommended by the network device for compressing the CSI by the model;
receiving the performance information of the model sent by the terminal comprises:
receiving the performance information of the model sent by the terminal based on the report configuration information.

16. The method according to claim 11, wherein the performance information is determined by performance parameters of the model, wherein the performance parameters comprise a performance metric of the model and corresponding overhead parameters for encoding the CSI.

17.-18. (canceled)

19. The method according to claim 11, wherein the performance information is determined by model type information of the model, and the model type information corresponds to predetermined information;
the predetermined information indicates at least one of:
performance parameters of the model;
model training mode;
model training time; and
model training batch.

20. The method according to claim 11, wherein the performance information is determined by compression results of the model, wherein the compression results comprise at least two compression results obtained by encoding the CSI obtained from a same channel measurement at least twice based on the different overhead parameters.

21.-23. (canceled)

24. A communication device, comprising:
an antenna;
a memory; and
a processor connected to the antenna and the memory respectively, configured to control transmission and reception through the antenna by executing computer executable instructions stored in the memory, and configured to:
send performance information of a model based on different overhead parameters to a network device;
wherein the model is configured to encode channel state information (CSI) based on the overhead parameters.

25. A non-transitory computer storage medium, wherein the computer storage medium stores computer executable instructions, and the computer executable instructions can implement the method according to claim 1 after being executed by the processor.

26. A communication device, comprising:
an antenna;
a memory; and
a processor connected to the antenna and the memory respectively, configured to control transmission and reception through the antenna by executing computer executable instructions stored in the memory, and capable of implementing the method according to claim 11.

27. A non-transitory computer storage medium, wherein the computer storage medium stores computer executable instructions, and the computer executable instructions can implement the method according to claim 11 after being executed by the processor.
